(19) United States
(12) Patent Application Publication
(10) Pub. No.: US 2017/0303211 A1
(43) Pub. Date: Oct. 19, 2017

(54) USER TERMINAL, RADIO BASE STATION, AND RADIO COMMUNICATION METHOD

(71) Applicant: NTT DOCOMO, INC., Tokyo (JP)

(72) Inventors: Kazuki Takeda, Tokyo (JP); Satoshi Nagata, Tokyo (JP); Lihui Wang, Beijing (CN); Liu Liu, Beijing (CN); Huiling Jiang, Beijing (CN)

(73) Assignee: NTT DOCOMO, INC., Tokyo (JP)

(21) Appl. No.: 15/513,837

(22) PCT Filed: Sep. 25, 2015
(86) PCT No.: PCT/JP2015/077079

§ 371 Date: Mar. 23, 2017

(30) Foreign Application Priority Data
Sep. 25, 2014 (JP) 2014-195104

(51) Int. Cl. H04W 52/32; H04L 5/00; H04W 72/04; H04L 12/24; H04W 88/08; H04W 88/06

(52) U.S. Cl. CPC H04W 52/32; H04W 72/0446; H04L 41/0803; H04L 5/0048; H04W 88/06; H04W 88/08

(57) ABSTRACT

According to the present disclosure, in dual connectivity, a radio base station can appropriately discern whether a user terminal has dropped the SRS, and can appropriately discern power scaling. A user terminal configured to carry out communication, using dual connectivity, with a first radio base station that configures a first cell group and a second radio base station that configures a second cell group, and a control section that controls an SRS transmission power for each cell group is provided. The user terminal includes a transmitting section that transmits a sounding reference signal (SRS) to each cell group. The control section decides the SRS transmission power for each cell group in accordance with whether or not a required power for the radio base station is allocated as the SRS transmission power.

### TECHNICAL FIELD

The present invention relates to a user terminal, a radio base station and a radio communication method in a next-generation mobile communication system.

### BACKGROUND ART

In a UMTS (Universal Mobile Telecommunications System) network, long-term evolution (LTE) has been standardized for the purposes of further increasing high-speed data rates and providing low delay, etc. (non-patent literature 1).

In LTE, as multiple access schemes, a scheme that is based on OFDMA (Orthogonal Frequency Division Multiple Access) is used in downlink channels (the downlink), and a scheme that is based on SC-FDMA (Single Carrier Frequency Division Multiple Access) is used in uplink channels (the uplink).

For the purposes of achieving further broadbandization and higher speed, successor systems to LTE are also under consideration, which are called, for example, LTE advanced or LTE enhancement, and are specified in LTE Rel. 10/11.

The system band of LTE Rel. 10/11 includes at least one component carrier (CC), in which the LTE system band constitutes one unit. Such bundling of a plurality of CCs into a wide band is referred to as “carrier aggregation” (CA).

In LTE Rel. 12, which is a more advanced successor system of LTE, various scenarios to use a plurality of cells in different frequency bands (carriers) are under consideration. When radio base stations forming a plurality of cells are substantially the same, the above-described carrier aggregation (CA) can be applied. Whereas, when the radio base stations forming a plurality of cells are completely different, dual connectivity (DC) may be applied.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall description; Stage 2”.

### SUMMARY OF INVENTION

### Technical Problem

In dual connectivity, if a sounding reference signal (SRS) is simultaneously transmitted with other uplink transmission, the radio base station cannot discern whether the user terminal has dropped the SRS, or how much transmission power has been allocated to the SRS.

The present invention has been devised in view of the above discussion, and it is an object of the present invention to provide a user terminal, a radio base station and a radio communication method in which, in dual connectivity, the radio base station can appropriately discern whether the user terminal has dropped the SRS, and can appropriately discern power scaling.

### Solution to Problem

According to the present invention, a user terminal is configured to carry out communication, using dual connectivity, with a first radio base station that configures a first cell group and a second radio base station that configures a second cell group, said user terminal including a transmitting section configured to transmit a sounding reference signal (SRS) to each cell group; and a control section configured to control an SRS transmission power for each cell group. The control section decides the SRS transmission power for each cell group in accordance with whether or not a required power for the radio base station is allocated as the SRS transmission power.

### Technical Advantageous of Invention

According to the present invention, in dual connectivity, a radio base station can appropriately discern whether a user terminal has dropped the SRS, and can appropriately discern power scaling.

### BRIEF DESCRIPTION OF DRAWINGS

FIG. 1 is an explanatory diagram in regard to SRS power control in carrier aggregation.

FIG. 2 shows explanatory diagrams in regard to SRS power control in carrier aggregation.

FIG. 3 shows explanatory diagrams in regard to SRS power control in dual connectivity.

FIG. 4 shows explanatory diagrams of a transmission comb.

FIG. 5 shows explanatory diagrams in regard to SRS power control in dual connectivity.

FIG. 6 shows explanatory diagrams in regard to SRS power control in dual connectivity.

FIG. 7 shows explanatory diagrams in regard to SRS power control in dual connectivity.

FIG. 8 shows explanatory diagrams in regard to SRS power control in dual connectivity.

FIG. 9 is an illustrative diagram of a schematic configuration of a radio communication system of according to an illustrated embodiment of the present invention.

FIG. 10 is an illustrative diagram of an overall configuration of a radio base station according to the illustrated embodiment of the present invention.

FIG. 11 is an illustrative diagram of a functional configuration of the radio base station according to the illustrated embodiment of the present invention.

FIG. 12 is an illustrative diagram of an overall configuration of a user terminal according to the illustrated embodiment of the present invention.

FIG. 13 is an illustrative diagram of a functional configuration of the user terminal according to the illustrated embodiment of the present invention.

### DESCRIPTION OF EMBODIMENTS

Details of an embodiment of the present invention will be hereinafter described with reference to the drawings.

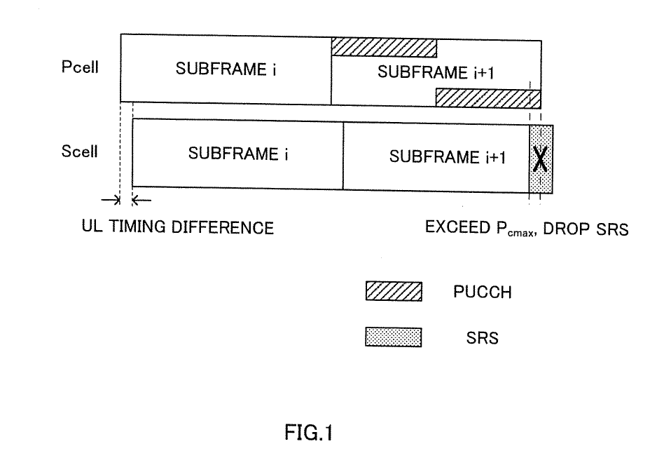

First of all, the power control for the sounding reference signal (SRS) in LTE Rel. 11 carrier aggregation will be herein discussed. As shown in FIG. 1, if the SRS symbol is simultaneously transmitted with a PUSCH (Physical Uplink Shared Channel) and a PUCCH (Physical Uplink Control Channel) or a PRACH (Physical Random Access Channel) of another serving cell, and the total transmission power of the symbol overlapping part exceeds a maximum allowable transmission power P_{cmax} of a user terminal, the user terminal performs a dropping process on the SRS.

In LTE Rel. 11 carrier aggregation, if the SRS symbol is simultaneously transmitted with an SRS of another serving cell, and the total transmission power of the symbol overlapping part exceeds a maximum allowable transmission power P_{cmax} of a user terminal, the user terminal performs a scaling down (power scaling process) on the transmission power, using the same coefficient, of all SRS.

In the case where carrier aggregation is applied, since a single scheduler controls the scheduling of a plurality of cells, the radio base station can discern when the user terminal has dropped the SRS, or when power scaling can been performed.

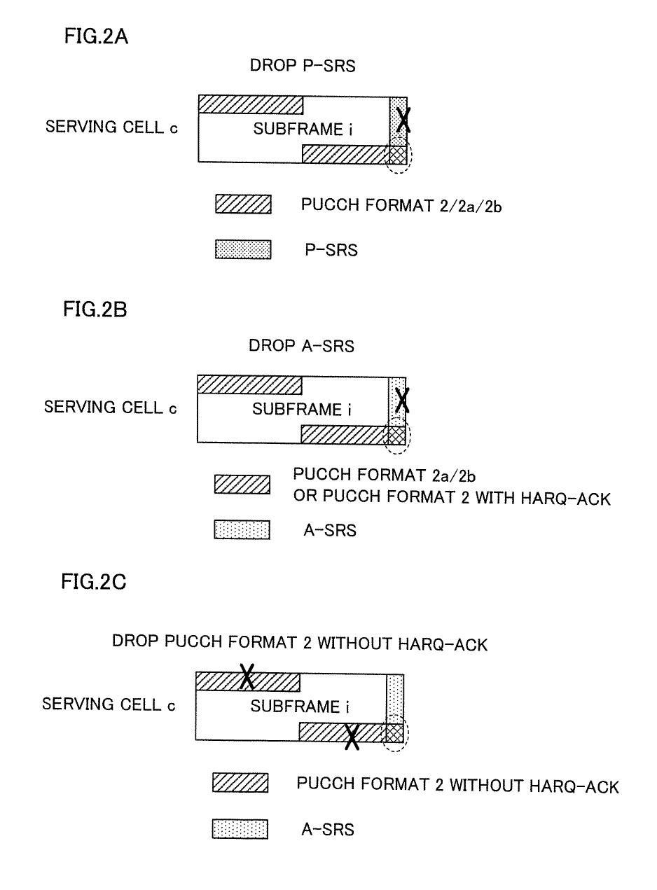

In the case where carrier aggregation is applied, in the same subframe of the same serving cell, when simultaneous transmission between a periodic SRS (P (Periodic)-SRS) and PUCCH format 2/2a/2b occurs, the user terminal is configured to perform a dropping process on the P-SRS (see FIG. 2A).

In the case where carrier aggregation is applied, in the same subframe of the same serving cell, when simultaneous transmission between an aperiodic SRS (A (Aperiodic)-SRS) and PUCCH format 2a/2b or PUCCH format 2 with an HARQ-ACK occurs, the user terminal is configured to perform a dropping process on the A-SRS (see FIG. 2B).

In the case where carrier aggregation is applied, in the same subframe of the same serving cell, when simultaneous transmission between an A-SRS and PUCCH format 2 without an HARQ-ACK occurs, the user terminal is configured to perform a dropping process on the PUCCH format 2 without an HARQ-ACK (see FIG. 2C).

In the case where dual connectivity is applied, a plurality of schedulers are independently provided, and each of the plurality of schedulers controls the scheduling of one or more cells under its jurisdiction. Specifically, a scheduler of a master base station (MeNB: master eNB) performs the scheduling of component carriers belonging to a master cell group (MCG). Furthermore, a scheduler of a secondary base station (SeNB: secondary eNB) performs the scheduling of component carriers belonging to a secondary cell group (SCG).

In dual connectivity, the master base station and the secondary base station are connected to each other with a backhaul having a delay that cannot be ignored (up to several scores of μs). In the scheduling between the master cell group and the secondary cell group, it is assumed that a dynamic cooperative control corresponding to the subframe length is impossible. Furthermore, in dual connectivity, two operations are possible: one case in which the master base station MeNB and the secondary base station SeNB are synchronized at a defined precision, and another case in which such synchronization has not been considered at all.

As discussed above, in dual connectivity, although the master base station MeNB and the secondary base station SeNB both can carry out uplink control (scheduling control and transmission power control) of the cell groups that they schedule, with respect to a user terminal, another cell group cannot discern what kind of uplink control is being performed. In regard to SRS, it cannot be discerned whether the SRS transmission in one cell group is simultaneously performed with PRACH/PUCCH/PUSCH/SRS transmission of another cell group, and whether or not there is a lack of transmission power for the user terminal if transmission is simultaneously performed. Accordingly, each radio base station cannot discern how the SRS is being controlled by the user terminal.

More specifically, each radio base station cannot discern whether the SRS has been dropped by the user terminal, or whether power scaling has been carried out with respect to the SRS. Regardless of which control has been carried out on the SRS, the radio base stations cannot discern how much transmission power is being used by the user terminal to transmit the SRS. The SRS is used to measure the uplink channel quality at the radio base station. Furthermore, the SRS is also utilized for measuring the downlink channel quality for time-division-duplexing (TDD). Hence, if the SRS transmission power changes without the radio base station detecting such a change, there is a possibility of this causing an adverse effect on the scheduling control.

In dual connectivity, the concept of “guaranteed transmission power (minimum guaranteed power)” per cell group is introduced for at least PUCCH/PUSCH transmission. P_{MeNB} designates the guaranteed transmission power of the master cell group (MCG), and P_{SeNB} designates the guaranteed transmission power of the secondary cell group (SCG). The master base station MeNB or the secondary base station SeNB notifies the user terminal of either both or one of the guaranteed transmission powers P_{MeNB} and P_{SeNB} via higher layer signaling such as RRC (Radio Resource Control), etc.

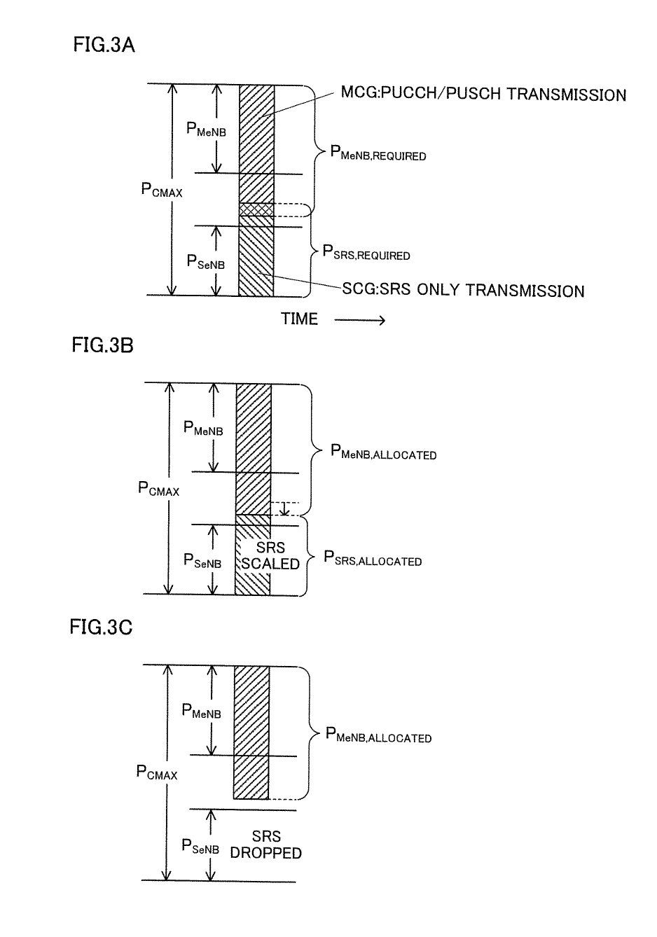

In FIG. 3A, P_{CMAX} indicates the maximum allowable transmission power of the user terminal, P_{MeNB} indicates the guaranteed transmission power of the master cell group, and P_{SeNB} indicates the guaranteed transmission power of the secondary cell group.

In FIG. 3A, PUCCH/PUSCH transmission is triggered from the master base station MeNB. Upon the user terminal calculating the transmission power to the master cell group (MCG), the necessary transmission power (required power) is P_{MeNB,required}.

In FIG. 3A, only the SRS transmission is triggered from the secondary base station SeNB. Upon the user terminal calculating the transmission power to the secondary cell group (SCG), the necessary transmission power (required power) is P_{srs,required}.

In the example shown in FIG. 3A, power exceeding the guaranteed transmission power P_{MeNB} is required from the master base station MeNB, and power exceeding the guaranteed transmission power P_{SeNB} is required from the secondary base station SeNB. Accordingly, in the example shown in FIG. 3A, the sum total of the transmission power for all of the component carriers in both cell groups exceeds the maximum allowable transmission power P_{CMAX} of the user terminal.

Generally, it is desirable for the power to be preferentially allocated in the PUCCH/PUSCH, which includes the actual data and control information, rather than the SRS which is utilized in channel quality measurement. Hereinbelow, it is assumed that the user terminal prioritizes the power allocation of the PUCCH/PUSCH transmission over the SRS transmission. The user terminal allocates the required power for the master cell group as transmission power (P_{MeNB,allocated}=P_{MeNB,required}). The user terminal applies scaling on the SRS transmission power (see FIG. 3B), or applies a dropping process on the SRS (see FIG. 3C).

In the example shown in FIG. 3B, the user terminal allocates a remaining power, obtained by subtracting the master cell group transmission power from the maximum allowable transmission power P_{CMAX} of the user terminal, as SRS transmission power for the secondary cell group (P_{srs, allocated}).

In the example shown in FIG. 3C, the user terminal applies a dropping process on the SRS with respect to the secondary cell group.

In the example shown in FIG. 3, the secondary base station SeNB cannot discern whether the user terminal has dropped the SRS, or how much transmission power has been allocated to the SRS upon power scaling. Accordingly, a low SINR (signal-to-interference plus noise power ratio) is estimated in the secondary base station SeNB, thereby causing problems with the throughput of the user terminal deteriorating.

Whereas, the inventors of the present invention, in regard to dual connectivity, arrived at a configuration in which a radio base station XeNB (a master base station MeNB or a secondary base station SeNB) can know an accurate SRS transmission power. Specifically, the inventors of the present invention arrived at a configuration (example 1) which decides the SRS configuration for the user terminal to use depending on whether or not the required power of the radio base station XeNB is allocated for SRS transmission power, and also arrived at a configuration (example 2) which decides that the user terminal use the SRS transmission power.

If the master base station MeNB and the secondary base station SeNB can accurately know the SRS transmission power, it becomes possible to improve the SINR estimation precision based on the power-scaled SRS transmission power.

### EXAMPLE 1

The user terminal decides on the SRS configuration to use depending on whether or not the required power of the radio base station XeNB (the master base station MeNB or the secondary base station SeNB) is allocated as SRS transmission power. The user terminal has two different SRS configurations. These SRS configurations may be configured or signaled by the radio base station XeNB, or may be prescribed by specifications.

If the required power for the radio base station XeNB is allocated as SRS transmission power, the user terminal uses the first SRS configuration. If the required power for the radio base station XeNB is not allocated as SRS transmission power, the user terminal uses the second SRS configuration if, e.g., power scaling has been carried out. The radio base station XeNB can discern whether the SRS has been transmitted via required power or by power-scaled transmission power by detecting whether the user terminal has used the first SRS configuration or the second SRS configuration. The radio base station XeNB can perform a control in which, based on whether the SRS is transmitted with required power or is power-scaled, for example, (1) the SRS that is transmitted with required power is used in detailed channel quality measurement, or (2) the power-scaled SRS is used to determine whether or not uplink synchronization is upheld.

The SRS configuration can include at least one of an SRS-comb, SRS bandwidth, SRS frequency position, or SRS cyclic shift. Hereinbelow, explanations are given using an SRS-comb as the SRS configuration.

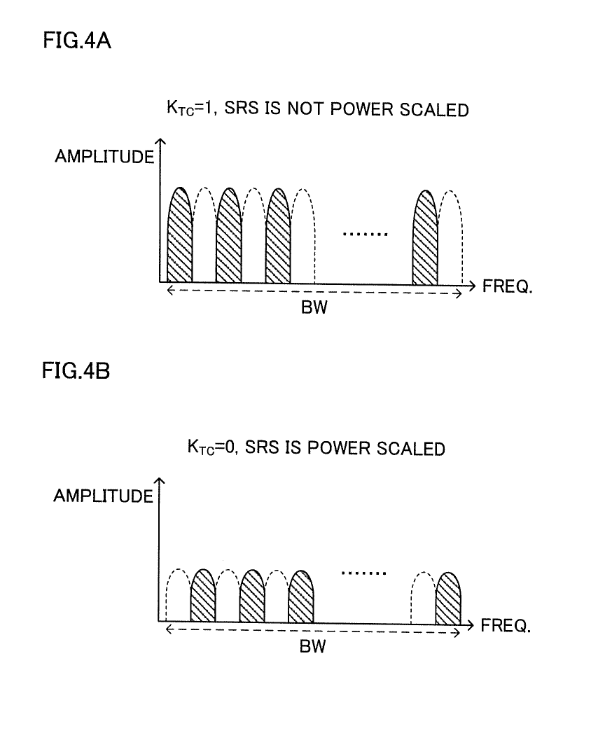

Using a transmission comb (TC) parameter K_{TC} implicitly indicates whether or not the SRS was transmitted by power-scaled transmission power. If SRS was not transmitted by power-scaled transmission power, i.e., in the case where the SRS was transmitted by required power, the user terminal transmits the SRS at odd-numbered sub-carriers, to which K_{TC}=1 has been allocated (see FIG. 4A). If the SRS was transmitted by power-scaled transmission power, the user terminal transmits the SRS at even-numbered sub-carriers, to which K_{TC}=0 has been allocated (see FIG. 4B). The radio base station XeNB can discern whether or not the SRS was transmitted by required power or by power-scaled transmission power by detecting the parameter K_{TC}={0, 1}.

If the reception powers from both of the parameters K_{TC}=1 and K_{TC}=0 are both extremely low, the radio base station XeNB can derive that the SRS has been dropped.

### EXAMPLE 2

The user terminal decides on the SRS transmission power to use depending on whether or not the required power of the radio base station XeNB (the master base station MeNB or the secondary base station SeNB) is allocated as SRS transmission power. If the required power for the radio base station XeNB is allocated as SRS transmission power, the user terminal transmits the SRS using the required power. If the required power for the radio base station XeNB is not allocated as SRS transmission power, the user terminal transmits the SRS using “predefined transmission power”.

The user terminal has two different types of predefined transmission power.

If the guaranteed transmission power P_{XeNB} is applied to the SRS, the predefined transmission power is the guaranteed transmission power P_{XeNB}. The guaranteed transmission power P_{XeNB} is notified from the radio base station XeNB by RRC.

If the guaranteed transmission power P_{XeNB} cannot be applied to the SRS, the predefined transmission power is a fixed target minimum reception SRS power P_{XeNB,srs,min}. The target minimum reception SRS power P_{XeNB,srs,min} is either notified from the radio base station XeNB by RRC or is defined by specifications.

In order for the radio base station to detect whether the required power has been allocated as the SRS transmission power, a different SRS configuration is used depending on whether the user terminal has allocated the require power or the predefined transmission power. The SRS configuration can include at least one of an SRS-comb, SRS bandwidth, SRS frequency position, or SRS cyclic shift. Hereinbelow, explanations are given using an SRS-comb as the SRS configuration.

Using a transmission comb parameter K_{TC} implicitly indicates whether or not the SRS was transmitted by the predefined transmission power. If SRS was not transmitted by the predefined transmission power, i.e., in the case where the SRS was transmitted by required power, the user terminal transmits the SRS at odd-numbered sub-carriers, to which K_{TC}=1 has been allocated. If the SRS was transmitted by the predefined transmission power, the user terminal transmits the SRS at even-numbered sub-carriers, to which K_{TC}=0 has been allocated. The radio base station XeNB can discern whether or not the SRS was transmitted by required power or by the predefined transmission power by detecting the parameter K_{TC}={0, 1}.

In the second example, each predefined transmission power is respectively considered for the case where (1) the guaranteed transmission power P_{MeNB} or P_{SeNB} can be applied to the SRS, and for the case where (2) the guaranteed transmission power P_{MeNB} or P_{SeNB} cannot be applied to the SRS.

In the case where (1) the guaranteed transmission power P_{XeNB} can be applied to the SRS, the user terminal transmits the SRS with the required power so long as the SRS required transmission power is less than or equal to the guaranteed transmission power P_{XeNB} (P_{srs,required}≦P_{XeNB}). If the SRS required transmission power exceeds the guaranteed transmission power P_{XeNB} (P_{srs,required}>P_{XeNB}), the user terminal performs power-scaling down to the guaranteed transmission power P_{XeNB}, which is transmission power that predefines the SRS transmission power, and transmits the SRS in the even-numbered sub-carriers.

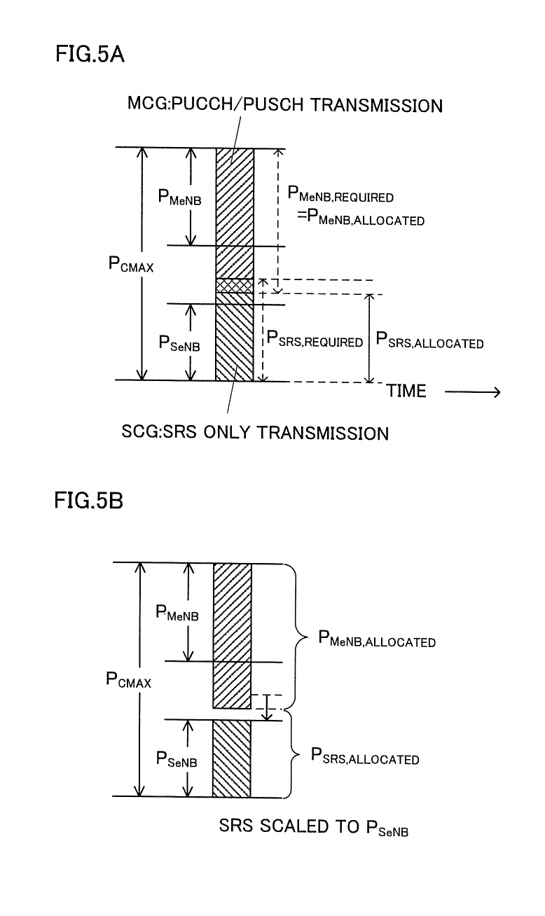

In FIG. 5A, P_{CMAX} designates the maximum allowable transmission power of the user terminal, P_{MeNB} designates the guaranteed transmission power for the master cell group, and P_{SeNB} designates the guaranteed transmission power for the secondary cell group.

In FIG. 5A, PUCCH/PUSCH transmission is triggered from the master base station MeNB. Upon the user terminal calculating the transmission power to the master cell group (MCG), the necessary transmission power (required power) is P_{MeNB,required}.

In FIG. 5A, only the SRS transmission is triggered from the secondary base station SeNB. Upon the user terminal calculating the transmission power to the secondary cell group (SCG), the necessary transmission power (required power) is P_{srs,required}.

The user terminal prioritizes the PUCCH/PUSCH transmission over the SRS transmission. Accordingly, the user terminal allocates the required power as transmission power for the master cell group (P_{MeNB, allocated}=P_{MeNB, required}). The required power P_{srs,required} for the secondary cell group is larger than a remaining power (P_{srs,allocated}), obtained by subtracting the master cell group transmission power from the maximum allowable transmission power P_{CMAX} of the user terminal, and exceeds the guaranteed transmission power P_{SeNB} (P_{srs,required}>P_{srs,allocated}≧P_{SeNB}).

Accordingly, the user terminal power-scales the SRS transmission power for the secondary cell group down to the guaranteed transmission power P_{SeNB} (see FIG. 5B), and transmits the SRS in the even-numbered sub-carriers.

The secondary base station SeNB knows that the SRS is transmitted by power-scaled transmission power by detecting the SRS in the even-numbered sub-carriers. Accordingly, the received SINR can be estimated by the following formula (1):

SINR_{scaled,i}=f(P_{srs,received,i}) (1),

wherein i indicates a carrier index within a cell group.

A conversion coefficient α can be obtained by the following formula (2):

$$α = \frac{{P}_{SeNB}}{{\sum }_{i} {P}_{srs , required , i}} , \qquad ( 2 )$$

wherein 0<α 1.

The SINR value can be corrected by the following formula (3):

$${SINR}_{real , i} = \frac{{SINR}_{scaled , i}}{α} . \qquad ( 3 )$$

Hence, the user throughput can be improved by calculating the value SINR_{real,i}.

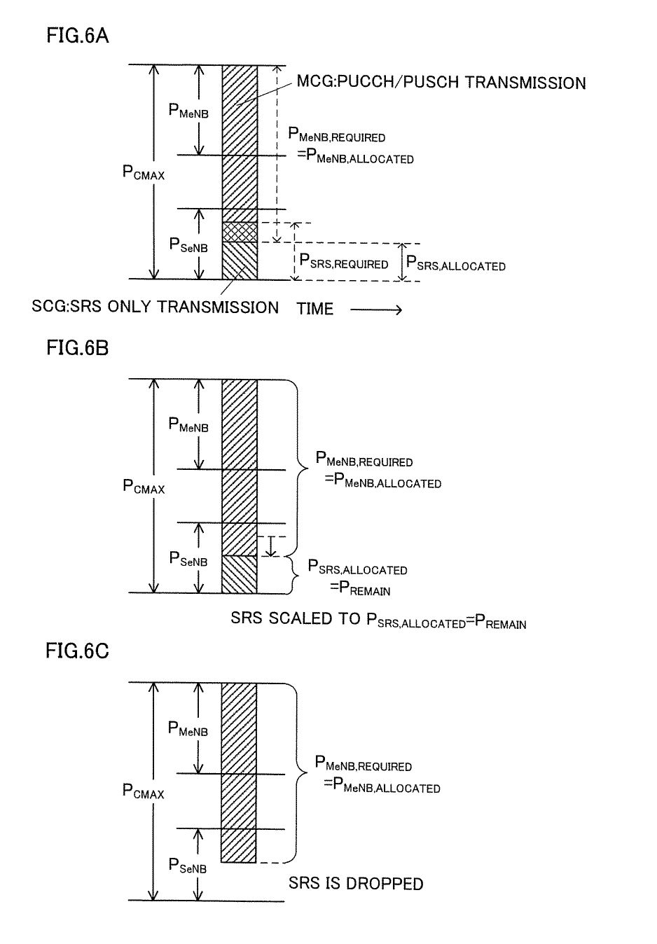

(2) In the case where the guaranteed transmission power P_{XeNB} cannot be applied to the SRS, since the SRS has the lowest priority, other uplink transmissions are first confirmed. Therefore, if a condition for guaranteeing SRS transmission is not attached, frequent dropping or power-scaling of the SRS would occur (see FIG. 6).

In FIG. 6A, P_{CMAX} indicates the maximum allowable transmission power of the user terminal, P_{MeNB} indicates the guaranteed transmission power of the master cell group, and P_{SeNB} indicates the guaranteed transmission power of the secondary cell group.

In FIG. 6A, PUCCH/PUSCH transmission is triggered from the master base station MeNB. Upon the user terminal calculating the transmission power to the master cell group (MCG), the necessary transmission power (required power) is P_{MeNB,required}.

In FIG. 6A, only the SRS transmission is triggered from the secondary base station SeNB. Upon the user terminal calculating the transmission power to the secondary cell group (SCG), the necessary transmission power (required power) is P_{srs,required}.

The user terminal prioritizes the PUCCH/PUSCH transmission over the SRS transmission. Accordingly, the user terminal allocates the required power as transmission power for the master cell group (P_{MeNB, allocated}=P_{MeNB, required}). The required power P_{srs,required} for the secondary cell group exceeds a remaining power (P_{srs,allocated}), obtained by subtracting the master cell group transmission power from the maximum allowable transmission power P_{CMAX} of the user terminal. Accordingly, the user terminal applies SRS transmission scaling (see FIG. 6B) or a dropping process on the SRS (see FIG. 6C).

In the example shown in FIG. 6B, the user terminal allocates a remaining power (P_{srs,allocated}), obtained by subtracting the master cell group transmission power from the maximum allowable transmission power P_{CMAX} of the user terminal, as SRS transmission power for the secondary cell group (P_{srs, allocated}=Pᵣₑₘₐᵢₙ).

In the example shown in FIG. 6C, the user terminal applies a dropping process on the SRS with respect to the secondary cell group.

Even in the case where the guaranteed transmission power P_{XeNB} cannot be applied to the SRS, a predefined transmission power as a fixed value P_{XeNB,srs,min} is introduced in order to increase the opportunity for efficient SRS transmission.

The radio base station XeNB decides the target minimum reception SRS power P_{XeNB,srs,min} based on the worst channel conditions. The value of the target minimum reception SRS power P_{XeNB,srs,min} is less than or equal to the guaranteed transmission power P_{XeNB} (P_{XeNB,srs,min}≦P_{XeNB}). The guaranteed transmission power P_{XeNB} is a dynamic value, and the target minimum reception SRS power P_{XeNB,srs,min} is a fixed value.

If the required power for the SRS is greater than the remaining power Pᵣₑₘₐᵢₙ and also exceeds the target minimum reception SRS power P_{XeNB,srs,min} (P_{srs,required}>Pᵣₑₘₐᵢₙ≧P_{XeNB,srs,min}), the user terminal applies power-scaling to the target minimum reception SRS power P_{XeNB,srs,min}, which is transmission power that predefines the SRS transmission power, and transmits the SRS in the even-numbered sub-carriers.

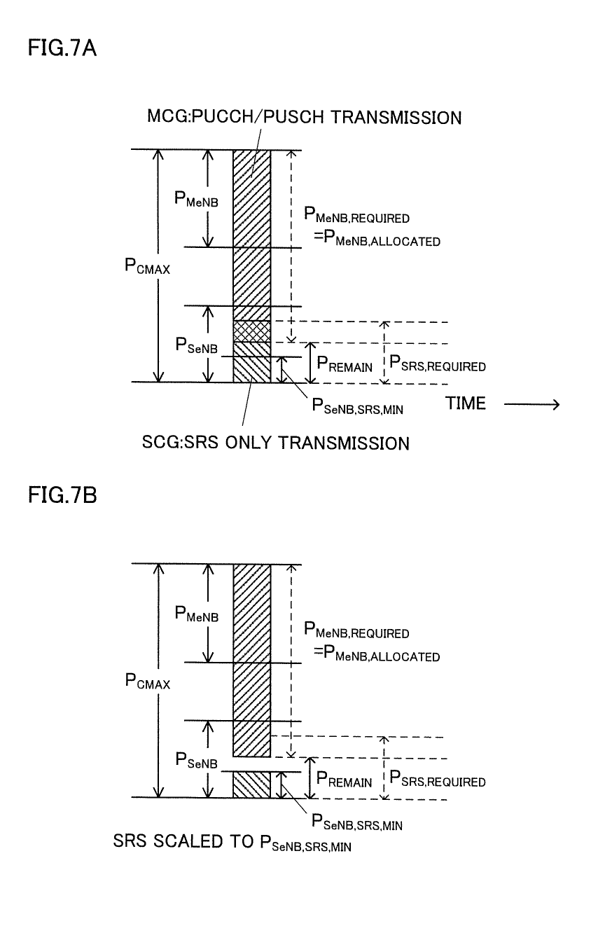

In FIG. 7A, P_{CMAX} indicates the maximum allowable transmission power of the user terminal, P_{MeNB} indicates the guaranteed transmission power of the master cell group, and P_{SeNB} indicates the guaranteed transmission power of the secondary cell group.

In FIG. 7A, PUCCH/PUSCH transmission is triggered from the master base station MeNB. Upon the user terminal calculating the transmission power to the master cell group (MCG), the necessary transmission power (required power) is P_{MeNB,required}.

In FIG. 7A, only the SRS transmission is triggered from the secondary base station SeNB. Upon the user terminal calculating the transmission power to the secondary cell group (SCG), the necessary transmission power (required power) is P_{srs,required}.

The user terminal prioritizes the PUCCH/PUSCH transmission over the SRS transmission. Accordingly, the user terminal allocates the required power as transmission power for the master cell group (P_{MeNB, allocated}=P_{MeNB, required}). The required power P_{srs,required} for the secondary cell group exceeds a remaining power (Pᵣₑₘₐᵢₙ), obtained by subtracting the master cell group transmission power from the maximum allowable transmission power P_{CMAX} of the user terminal, and also exceeds the target minimum reception SRS power P_{SeNB,srs,min} (P_{srs,required}>Pᵣₑₘₐᵢₙ≧P_{SeNB,srs,min}).

Accordingly, the user terminal power-scales the SRS transmission for the secondary cell group down to the target minimum reception SRS power P_{XeNB,srs,min} (see FIG. 7B), and transmits the SRS in the even-numbered sub-carriers.

The secondary base station SeNB knows that the SRS is transmitted by being power-scaled to the target minimum reception SRS power P_{XeNB,srs,min}, which is a predefined transmission power, by detecting the SRS in the even-numbered sub-carriers. Accordingly, the received SINR can be estimated by the following formula (4):

SINR_{scaled,i}=f(P_{srs,received,i}) (4),

wherein i indicates a carrier index within a cell group.

A conversion coefficient α can be obtained by the following formula (5):

$$α = \frac{{P}_{SeNB , srs , min}}{{\sum }_{i} {P}_{srs , required , i}} , \qquad ( 5 )$$

wherein 0<α<1.

The SINR value can be corrected by the following formula (6):

$${SINR}_{real , i} = \frac{{SINR}_{scaled , i}}{α} . \qquad ( 6 )$$

Hence, the user throughput can be improved by calculating the value SINR_{real,i}.

If the remaining power Pᵣₑₘₐᵢₙ is smaller than the target minimum reception SRS power P_{XeNB,srs,min} (Pᵣₑₘₐᵢₙ<P_{XeNB,srs,min}), the user terminal can apply a dropping process on the SRS.

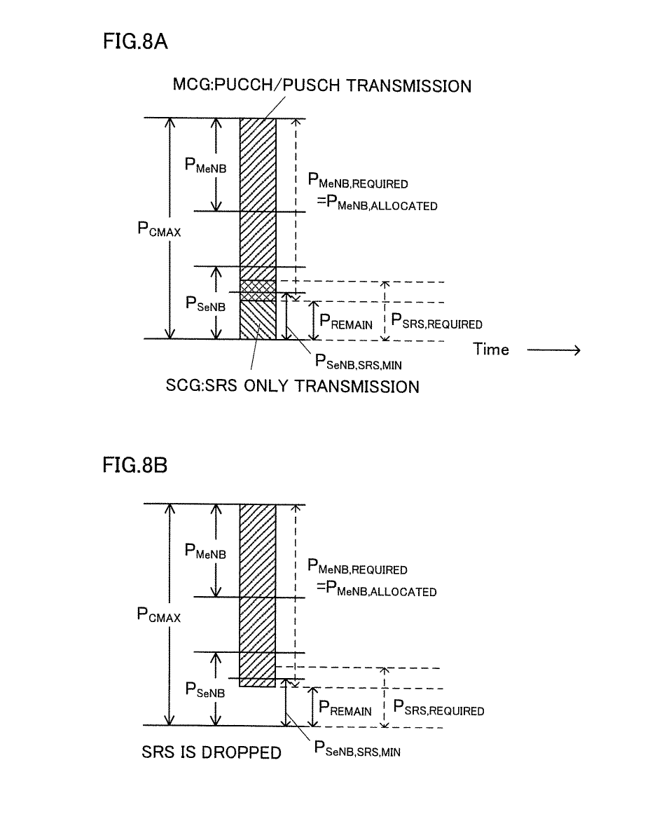

In FIG. 8A, P_{CMAX} indicates the maximum allowable transmission power of the user terminal, P_{MeNB} indicates the guaranteed transmission power of the master cell group, and P_{SeNB} indicates the guaranteed transmission power of the secondary cell group.

In FIG. 8A, PUCCH/PUSCH transmission is triggered from the master base station MeNB. Upon the user terminal calculating the transmission power to the master cell group (MCG), the necessary transmission power (required power) is P_{MeNB,required}.

In FIG. 8A, only the SRS transmission is triggered from the secondary base station SeNB. Upon the user terminal calculating the transmission power to the secondary cell group (SCG), the necessary transmission power (required power) is P_{srs,required}.

The user terminal prioritizes the PUCCH/PUSCH transmission over the SRS transmission. Accordingly, the user terminal allocates the required power as transmission power for the master cell group (P_{MeNB, allocated}=P_{MeNB,required}). The remaining power (Pᵣₑₘₐᵢₙ), obtained by subtracting the master cell group transmission power from the maximum allowable transmission power P_{CMAX} of the user terminal is less than the target minimum reception SRS power P_{SeNB,srs,min} (Pᵣₑₘₐᵢₙ<P_{SeNB,srs,min}).

Accordingly, the user terminal performs a dropping process on the SRS (see FIG. 8B).

If the SRS reception powers of the even-numbered and odd-numbered sub-carriers are both extremely low, the secondary base station SeNB can presume that the SRS has been dropped. In such a case, the secondary base station SeNB, with respect to the user terminal, either carries out scheduling based on a prior SINR, or carries out scheduling with a conservative modulation and coding set (MCS).

In LTE Rel. 11 carrier aggregation, an aperiodic SRS (A-SRS) has a higher priority than periodic channel state information (CSI). A periodic SRS (P-SRS) has the lowest priority. Accordingly, it is logical to apply the guaranteed transmission power P_{XeNB} to an aperiodic SRS (A-SRS) and not to apply the guaranteed transmission power P_{XeNB} to a periodic SRS (P-SRS). Therefore, it is desirable to apply the first example and the second example (1, the guaranteed transmission power P_{XeNB} is applied to the SRS as a predefined transmission power) to the power control of an aperiodic SRS (A-SRS). It is desirable to apply the first example and the second example (2, the guaranteed transmission power P_{XeNB} is not applied to the SRS as a predefined transmission power) to the power control of a periodic SRS (P-SRS)

(Configuration of Radio Communication System)

The following description concerns the configuration of a radio communication system according to an embodiment of the present invention. In this radio communication system, a radio communication method which performs the above-described power control is adopted.

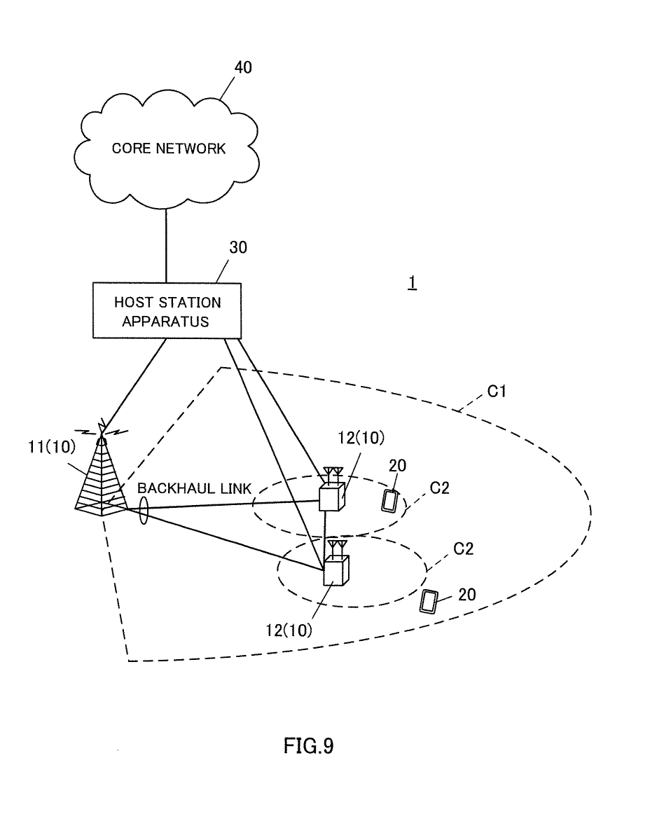

FIG. 9 is a schematic structure diagram showing an example of the radio communication system according to the present embodiment. As shown in FIG. 9, a radio communication system 1 includes a plurality of radio base stations 10 (11 and 12), and a plurality of user terminals 20 that are present within cells formed by each radio base station 10 and are configured to be capable of communicating with each radio base station 10. The radio base stations 10 are each connected with a host station apparatus 30, and are connected to a core network 40 via the host station apparatus 30.

In FIG. 9, the radio base station 11 is, for example, a macro base station having a relatively wide coverage, and forms a macro cell C1. The radio base stations 12 are small base stations having local coverage, and form small cells C2. Note that the number of radio base stations 11 and 12 is not limited to that shown in FIG. 9.

In the macro cell C1 and the small cells C2, the same frequency band may be used, or different frequency bands may be used. Furthermore, the macro base stations 11 and 12 are connected with each other via an inter-base station interface (for example, optical fiber, the X2 interface, etc.).

Between the radio base station 11 and the radio base stations 12, between the radio base station 11 and other radio base stations 11, or between the radio base stations 12 and other radio base stations 12, dual connectivity mode (DC) or carrier aggregation (CA) is employed.

User terminals 20 are terminals to support various communication schemes such as LTE, LTE-A, etc., and may include both mobile communication terminals and stationary communication terminals. The user terminals 20 can communicate with other user terminals 20 via the radio base stations 10.

Note that the host station apparatus 30 may be, for example, an access gateway apparatus, a radio network controller (RNC), a mobility management entity (MME), etc., but is not limited thereto.

In the radio communication system 1, a downlink shared channel (PDSCH: Physical Downlink Shared Channel), which is shared by each user terminal 20, downlink control channels (PDCCH (Physical Downlink Control Channel), EPDCCH (Enhanced Physical Downlink Control Channel), etc.), a broadcast channel (PBCH), etc., are used as downlink channels. User data, higher layer control information and predetermined SIBs (System Information Blocks) are communicated in the PDSCH. Downlink control information (DCI) is communicated in the PDCCH and the EPDCCH.

In the radio communication system 1, an uplink shared channel (PUSCH: Physical Uplink Shared Channel), which is shared by each user terminal 20, an uplink control channel (PUCCH: Physical Uplink Control Channel), etc., are used as uplink channels. User data and higher layer control information are communicated in the PUSCH.

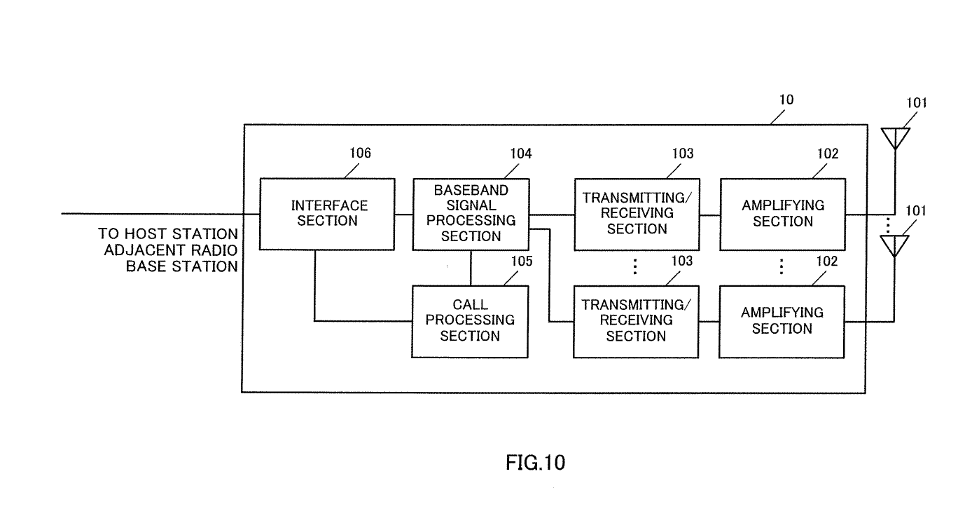

FIG. 10 is a diagram to show an overall structure of a radio base station 10 according to the present embodiment. As shown in FIG. 10, the radio base station 10 has a plurality of transmitting/receiving antennas 101 for MIMO (multiple-input and multiple output) communication, amplifying sections 102, transmitting/receiving sections (transmitting sections and receiving sections) 103, a baseband signal processing section 104, a call processing section 105 and an interface section 106.

User data to be transmitted from the radio base station 10 to a user terminal 20 on the downlink is input from the host station apparatus 30, into the baseband signal processing section 104, via the interface section 106.

In the baseband signal processing section 104, a PDCP (Packet Data Convergence Protocol) layer process, division and coupling of user data, RLC (Radio Link Control) layer transmission processes such as an RLC retransmission control transmission process, MAC (Medium Access Control) retransmission control, including, for example, an HARQ (Hybrid Automatic Repeat reQuest) transmission process, scheduling, transport format selection, channel coding, an inverse fast Fourier transform (IFFT) process, and a precoding process are performed, and the result is forwarded to each transmitting/receiving section 103. Furthermore, downlink control signals are also subjected to transmission processes such as channel coding and an inverse fast Fourier transform, and are forwarded to each transmitting/receiving section 103.

Each transmitting/receiving section 103 converts the downlink signals, pre-coded and output from the baseband signal processing section 104 on a per antenna basis, into a radio frequency band. The amplifying sections 102 amplify the radio frequency signals having been subjected to frequency conversion, and transmit the resulting signals via the transmitting/receiving antennas 101. Based on common recognition in the field of the art pertaining to the present invention, the transmitting/receiving section 103 can be applied to a transmitter/receiver, a transmitter/receiver circuit or a transmitter/receiver device.

Whereas, in regard to the uplink signals, radio frequency signals received by each transmission/reception antenna 101 are amplified by each amplifying section 102, subjected to frequency conversion in each transmitting/receiving section 103 and converted into baseband signals and the converted signals are then input to the baseband signal processing section 104.

The baseband signal processing section 104 performs FFT (Fast Fourier Transform) processing, IDFT (Inverse Discrete Fourier Transform) processing, error correction decoding, MAC retransmission control reception processing, and RLC layer and PDCP layer reception processing on user data included in the input uplink signals. The signals are then transferred to the host station apparatus 30 via the interface section 106. The call processing section 105 performs call processing such as setting up and releasing a communication channel, manages the state of the radio base station 10, and manages the radio resources.

The interface section 106 performs transmission and reception of signals (backhaul signaling) with a neighbor radio base station via an inter-base-station interface (for example, optical fiber, X2 interface). Alternatively, the interface section 106 performs transmission and reception of signals with the host station apparatus 30 via a predetermined interface.

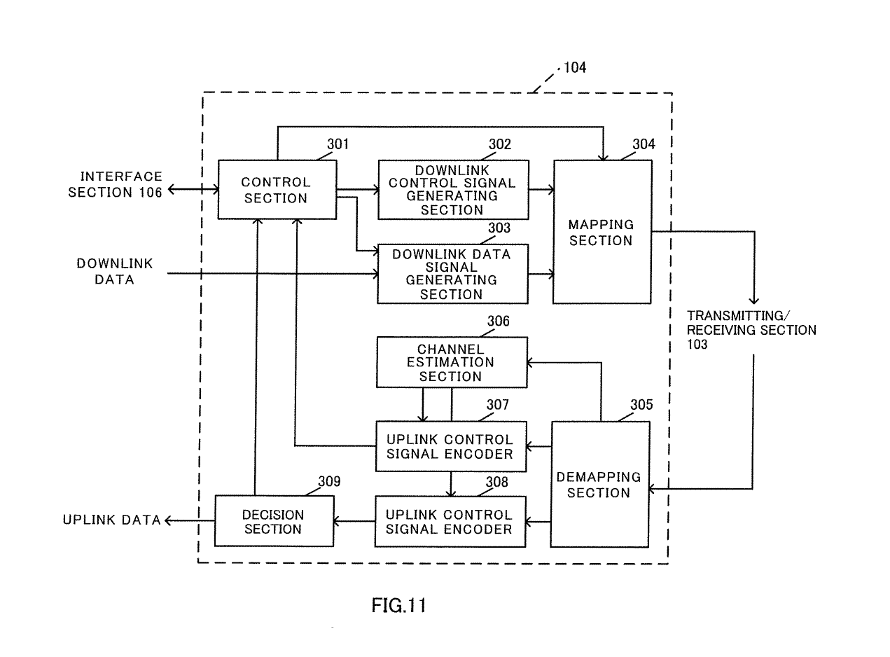

FIG. 11 is a diagram illustrating main functional structures of the baseband signal processing section 104 provided in the radio base station 10 according to the present embodiment. As illustrated in FIG. 11, the baseband signal processing section 104 provided in the radio base station 10 is configured to include at least a control section 301, a downlink control signal generating section 302, a downlink data signal generating section 303, a mapping section 304, a demapping section 305, a channel estimation section 306, an uplink control signal decoding section 307, an uplink data signal decoding section 308, and a decision section 309.

The control section 301 controls scheduling of downlink user data to be transmitted on PDSCH downlink reference signals, downlink control information to be transmitted on either or both of PDCCH and enhanced PDCCH (EPDCCH), and downlink reference signals, etc. Furthermore, the control section 301 also performs control of scheduling (allocation control) of RA preamble to be transmitted on PRACH, uplink data to be transmitted on PUSCH, uplink control information and uplink reference signals to be transmitted on PUCCH or PUSCH. Information about allocation of uplink signals (uplink control signals and uplink user data) is transmitted to the user terminal 20 using downlink control signals (DCI).

The control section 301 controls allocation of radio resources to downlink signals and uplink signals based on feedback information from each user terminal 20 and instruction information from the host station apparatus 30. In other words, the control section 301 serves as a scheduler. Based on common recognition in the field of the art pertaining to the present invention, the control section 301 can be applied to a controller, a control circuit or a control device.

The downlink control signal generating section 302 generates downlink control signals (both or either of PDCCH signals and EPDCCH signals) that have been allocated by the control section 301. Specifically, the downlink control signal generating section 302 generates a downlink assignment to notify the user terminal of allocation of downlink signals, and an uplink grant to notify the user terminal of allocation of uplink signals based on instructions from the control section 301. Based on common recognition in the field of the art pertaining to the present invention, the downlink control signal generating section 302 can be applied to a signal generator or a signal generating circuit.

The downlink data signal generating section 303 generates downlink data signals (PDSCH signals), the allocation thereof to the resources having been determined by the control section 301. The data signals generated in the downlink data signal generating section 303 are subjected to a coding process and a modulation process, using coding rates and modulation schemes that are determined based on CSI, etc., from each user terminal 20.

The mapping section 304 controls the allocation of the downlink control signals generated in the downlink control signal generating section 302 and the downlink data signals generated in the downlink data signal generating section 303 to radio resources based on commands from the control section 301. Based on common recognition in the field of the art pertaining to the present invention, the mapping section 304 can be applied to a mapping circuit and a mapper.

The demapping section 305 demaps uplink signals transmitted from the user terminal 20 and separates the uplink signals. The channel estimation section 306 estimates channel states from the reference signals included in the received signals separated in the demapping section 305, and outputs the estimated channel states to the uplink control signal decoding section 307 and the uplink data signal decoding section 308.

The uplink control signal decoding section 307 decodes the feedback signals (delivery acknowledgement signals, etc.) transmitted from the user terminal in the uplink control channel (PRACH, PUCCH), and outputs the results to the control section 301. The uplink data signal decoding section 308 decodes the uplink data signals transmitted from the user terminals through an uplink shared channel (PUSCH), and outputs the results to the decision section 309. The decision section 309 makes retransmission control decisions (A/N decisions) based on the decoding results in the uplink data signal decoding section 308, and outputs results to the control section 301.

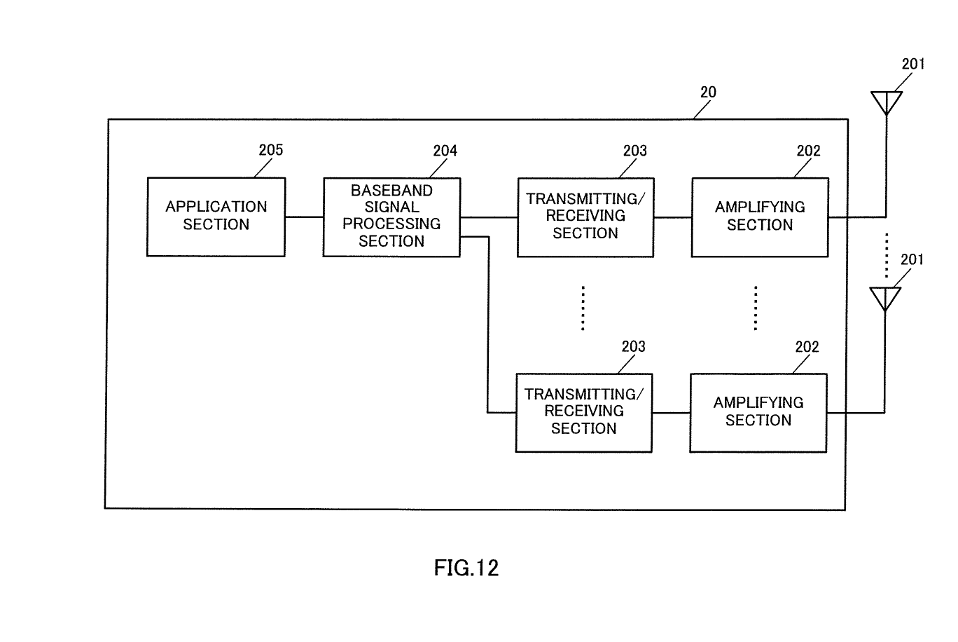

FIG. 12 is a diagram showing an overall structure of a user terminal 20 according to the present embodiment. As shown in FIG. 12, the user terminal 20 is provided with a plurality of transmitting/receiving antennas 201 for MIMO communication, amplifying sections 202, transmitting/receiving sections (transmitting sections and receiving sections) 203, a baseband signal processing section 204 and an application section 205.

In regard to downlink data, radio frequency signals that are received in the plurality of transmitting/receiving antennas 201 are each amplified in the amplifying sections 202, and subjected to frequency conversion and converted into the baseband signal in the transmitting/receiving sections 203. This baseband signal is subjected to an FFT process, error correction decoding, a retransmission control receiving process, etc., in the baseband signal processing section 204. Out of this downlink data, downlink user data is forwarded to the application section 205. The application section 205 performs processes related to higher layers above the physical layer and the MAC layer. Furthermore, out of the downlink data, broadcast information is also forwarded to the application section 205. Based on common recognition in the field of the art pertaining to the present invention, the transmitting/receiving section 203 can be applied to a transmitter/receiver, a transmitting/receiving circuit or a transmitting/receiving device.

On the other hand, uplink user data is input from the application section 205 to the baseband signal processing section 204. In the baseband signal processing section 204, a retransmission control (HARQ) transmission process, channel coding, precoding, a discrete fourier transform (DFT) process, an inverse fast fourier transform (IFFT) process, etc., are performed, and the result is forwarded to each transmitting/receiving section 203. The baseband signal that is output from the baseband signal processing section 204 is converted into a radio frequency band in the transmitting/receiving sections 203. Thereafter, the amplifying sections 202 amplify the radio frequency signal having been subjected to frequency conversion, and transmit the resulting signal from the transmitting/receiving antennas 201.

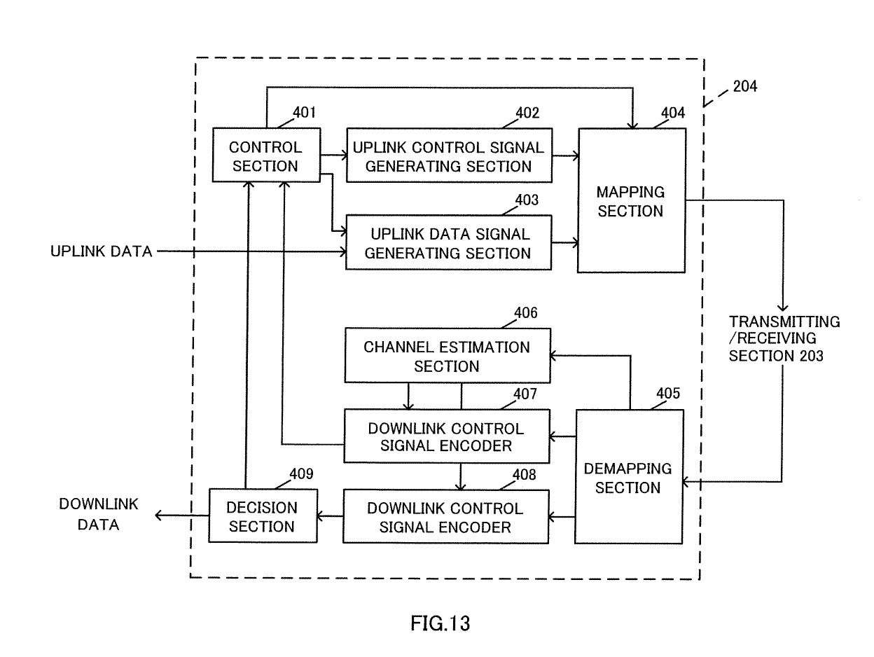

FIG. 13 is a diagram showing the main functional structure of the baseband signal processing section 204 provided in the user terminal 20. As shown in FIG. 13, the baseband signal processing section 204 provided in the user terminal 20 includes at least of a control section 401, an uplink control signal generating section 402, an uplink data signal generating section 403, a mapping section 404, a demapping section 405, a channel estimation section 406, a downlink control signal decoding section 407, a downlink data signal decoding section 408 and a decision section 409.

The control section 401 controls the generation of uplink control signals (A/N signals, etc.) and uplink data signals based on downlink control signals (PDCCH signals) transmitted from the radio base station 10, and retransmission control decisions in response to the PDSCH signals received. The downlink control signals received from the radio base station are output from the downlink control signal decoding section 407, and the retransmission control decisions are output from the decision section 409. Based on common recognition in the field of the art pertaining to the present invention, the control section 401 can be applied to a controller, a control circuit or a control device.

The control section 401 decides both of, or one of, the SRS configuration to use and the SRS transmission power depending on whether or not the required power of the radio base station 10 is allocated as a sounding reference signal (SRS) transmission power. For example, if the required power of the radio base station 10 is allocated as SRS transmission power, the control section 401 decides to use the first SRS configuration, and if the required power of the radio base station 10 is not allocated as SRS transmission power, the control section 401 decides to use the second SRS configuration. Furthermore, if the required power of the radio base station 10 is allocated as SRS transmission power, the control section 401 decides to transmit the SRS using the required power, and if the required power of the radio base station 10 is not allocated as SRS transmission power, the control section 401 decides to transmit the SRS using the predefined transmission power.

The uplink control signal generating section 402 generates uplink control signals (feedback signals such as delivery acknowledgement signals, channel state information (CSI), etc.) based on commands from the control section 401. The uplink data signal generating section 403 generates uplink data signals based on commands from the control section 401. Note that, when an uplink grant is contained in a downlink control signal reported from the radio base station, the control section 401 commands the uplink data signal generating section 403 to generate an uplink data signal. Based on common recognition in the field of the art pertaining to the present invention, the uplink control signal generating section 402 can be applied to a signal generator or a signal generation circuit.

The mapping section 404 controls the allocation of the uplink control signals (delivery acknowledgment signals, etc.) and the uplink data signals to radio resources (PUCCH, PUSCH) based on commands from the control section 401.

The demapping section 405 demaps downlink signals transmitted from the radio base station 10 and separates the downlink signals. The channel estimation section 406 estimates channel states from the reference signals included in the received signals separated in the demapping section 406, and outputs the estimated channel states to the downlink control signal decoding section 407 and the downlink data signal decoding section 408.

The downlink control signal decoding section 407 decodes the downlink control signals (PDCCH signals) transmitted in the downlink control channel (PDCCH), and outputs the scheduling information (information regarding the allocation to uplink resources) to the control section 401. In addition, if information related to the cells for feeding back delivery acknowledgment signals and information as to whether or not RF tuning is applied are included in downlink control signals, these pieces of information are also output to the control section 401.

The downlink data signal decoding section 408 decodes the downlink data signals transmitted in the downlink shared channel (PDSCH), and outputs the results to the decision section 409. The decision section 409 makes retransmission control decisions (A/N decisions) based on the decoding results in the downlink data signal decoding section 408, and outputs the results to the control section 401.

The present invention is by no means limited to the above embodiment and can be implemented in various modifications. The sizes and shapes illustrated in the accompanying drawings in relationship to the above embodiment are by no means limiting, and may be changed as appropriate within the scope of optimizing the effects of the present invention. Moreover, implementations with various appropriate changes may be possible without departing from the scope of the object of the present invention.

The disclosure of Japanese Patent Application No. 2014-195104, filed on Sep. 25, 2014, is incorporated herein by reference in its entirety.

1. A user terminal configured to carry out communication, using dual connectivity, with a first radio base station that configures a first cell group and a second radio base station that configures a second cell group, said user terminal comprising:
a transmitting section configured to transmit a sounding reference signal (SRS) to each cell group; and
a control section configured to control an SRS transmission power for each cell group,
wherein the control section decides the SRS transmission power for each cell group in accordance with whether or not a required power for the radio base station is allocated as the SRS transmission power.

2. The user terminal according to claim 1, wherein if the required power for the radio base station is allocated as the SRS transmission power, the control section decides to transmit the SRS using the required power.

3. The user terminal according to claim 1, wherein if the required power for the radio base station is not allocated as the SRS transmission power, the control section decides to transmit the SRS using a predefined transmission power.

4. The user terminal according to claim 3, wherein the predefined transmission power is a guaranteed transmission power that is set for at least one cell group.

5. The user terminal according to claim 1, wherein the first radio base station that configures the first cell group and the second radio base station that configures the second cell group apply synchronized dual connectivity.

6. A radio base station which configures a first cell group and is configured to carry out communication with a user terminal, using dual connectivity, together with another radio base station that configures a second cell group, said radio base station comprising:
a receiving section configured to receive a sounding reference signal (SRS) transmitted from the user terminal;
a control section configured to control a required transmission power for the SRS; and
a transmission section configured to transmit, to the user terminal, information regarding guaranteed transmission power that is determined for at least one cell group,
wherein the receiving section receives the SRS, the transmission power of which being controlled based on the required transmission power or the guaranteed transmission power.

7. A radio communication method for a user terminal configured to carry out communication, using dual connectivity, with a first radio base station that configures a first cell group and a second radio base station that configures a second cell group, said radio communication method comprising:
deciding a transmission power of a sounding reference signal (SRS) for each cell group;
transmitting the SRS to each cell group; and
deciding a SRS transmission power for each cell group in accordance with whether or not a required power for the radio base station is allocated as the SRS transmission power.

8. The user terminal according to claim 2, wherein if the required power for the radio base station is not allocated as the SRS transmission power, the control section decides to transmit the SRS using a predefined transmission power.

9. The user terminal according to claim 2, wherein the first radio base station that configures the first cell group and the second radio base station that configures the second cell group apply synchronized dual connectivity.

10. The user terminal according to claim 3, wherein the first radio base station that configures the first cell group and the second radio base station that configures the second cell group apply synchronized dual connectivity.

11. The user terminal according to claim 4, wherein the first radio base station that configures the first cell group and the second radio base station that configures the second cell group apply synchronized dual connectivity.
